(19) United States
(12) Patent Application Publication
(10) Pub. No.: US 2011/0292416 A1
(43) Pub. Date: Dec. 1, 2011

(54) PRINTER AND METHOD FOR PROCESSING DIGITAL IMAGE THEREIN

(75) Inventor: TENG-YU TSAI, Tu-Cheng (TW)

(73) Assignee: HON HAI PRECISION INDUSTRY CO., LTD., Tu-Cheng (TW)

(21) Appl. No.: 12/911,834

(22) Filed: Oct. 26, 2010

(30) Foreign Application Priority Data
May 27, 2010 (CN) 201010184942.1

(51) Int. Cl. H04N 1/60

(52) U.S. Cl. 358/1.9

(57) ABSTRACT

A stand-alone printer includes a storage module, a user interface module, a touch screen, a processing module, and a printing module. The storage module stores a digital image. The user interface module creates an adjusting scroll. The touch screen detects a slide operation and displays the digital image and the adjusting scroll. The processing module adjusts the digital image in response to the slide operation on the touch screen. The processing module outputs an adjusted digital image to the touch screen. The printing module prints the adjusted digital image.

### BACKGROUND

1. Technical Field

The present disclosure relates to a stand-alone printer and a method for processing a digital image in the stand-alone printer.

2. Description of Related Art

Typically, a printer is driven by a computer to print selected digital images. In this scenario, digital images are usually edited or manipulated by software processed by the computer prior to printing.

Subsequently, stand-alone printers were developed which enabled the digital images to be input directly to the printer using flash memory cards, and editing, such as cropping, or framing of the digital images can be done directly in the printer bypassing the need for a computer. These kinds of printers usually have an input panel and a simple display for previewing the digital images before printing. However, the editing must be done by navigating multiple menus at different levels. It is easy for a user to become disoriented and lose track of all of the available options.

Therefore, there is room for improvement within the art.

### BRIEF DESCRIPTION OF THE DRAWINGS

Many aspects of the embodiments can be better understood with references to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is a block view of a stand-alone printer in accordance with an exemplary embodiment.

FIG. 2 illustrates a simplified depiction of an adjusting interface of a digital image in the stand-alone printer in an exemplary embodiment.

FIG. 3 is a flowchart of a method for processing a digital image in a stand-alone printer in an exemplary embodiment.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

In general, the word “module,” as used herein, refers to logic embodied in hardware or firmware, or to a collection of software instructions, written in a programming language, such as, for example, Java, C, or assembly. One or more software instructions in the modules may be embedded in firmware, such as an EPROM. It will be appreciated that modules may comprise connected logic units, such as gates and flip-flops, and may comprise programmable units, such as programmable gate arrays or processors. The modules described herein may be implemented as either software and/or hardware modules and may be stored in any type of computer-readable medium or other computer storage device.

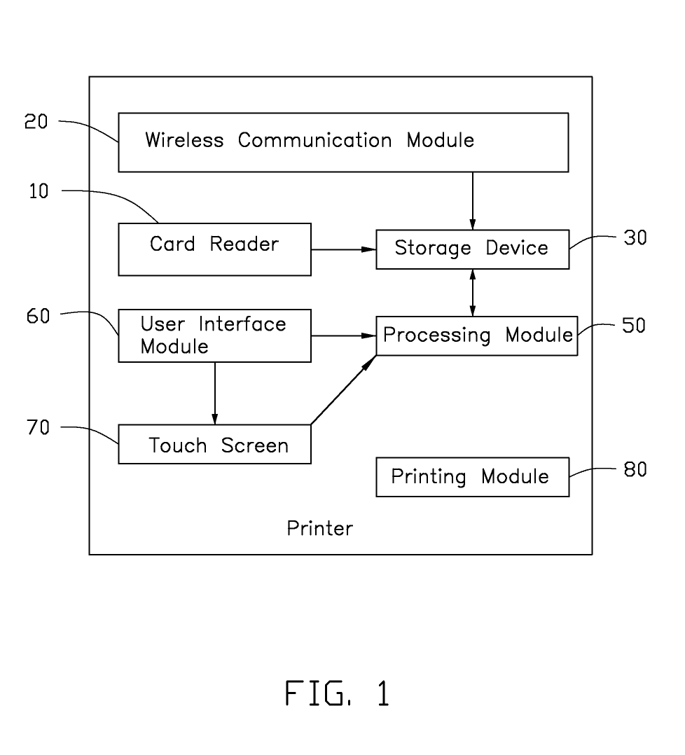

Referring to FIG. 1, a stand-alone printer in an exemplary embodiment may include a card reader 10, a wireless communication module 20, a storage device 30, a processing module 50, a user interface module 60, a touch screen 70, and a printing module 80. The printing module 80 includes a combination of electronic and mechanical systems, which can print the image. In one exemplary embodiment, the stand-alone printer is a laser printer. The printing module 80 may include a laser scanning device, a sensing drum, toner cartridges, imaging devices, static rollers, adhesive devices, paper transfer unit, cleaning blade, a paper feeder and a tray.

The card reader 10 is electronically connected to the storage device 30. The card reader 10 can directly read a storage card, such as Secure Digital (SD) card, Multi-Media (MMC) card, Compact Flash (CF) etc.

The wireless communication module 20 can also be electronically connected to the storage device. Therefore, the storage device 30 may also receive digital images through the wireless communication module 20, i.e., in addition or in place of the card reader 10.

The touch screen 70 is an electronic visual display that can detect the presence and location of a touch within the display area. The touch screen 70 can recognize a point operation or a slide operation performed with a finger or a stylus.

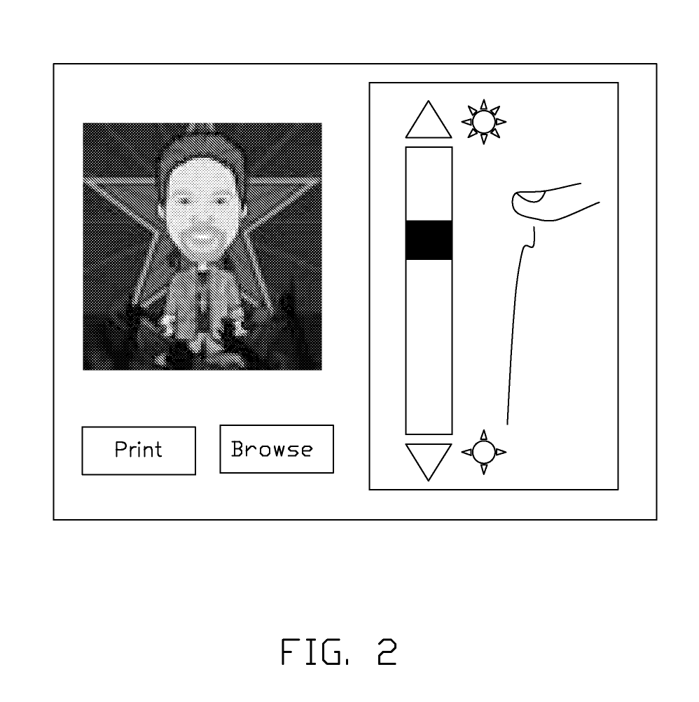

Referring to FIG. 2, the user interface module 60 in an exemplary embodiment can be a software program stored in the storage device. When the user interface is processed by the processing module 50, the user interface can create an adjusting scroll on the touch screen. As shown in FIG. 2, the adjusting scroll and a digital image from the storage device are displayed on the touch screen 70.

The processing module 50 can adjust one of more characteristics of the digital image, such as brightness, size, contrast, cropping position, arrangement direction of the digital image in response to the slide operation on the touch screen. In detail, the processing module 50 can calculate a percentage of a movement distance of the slide operation along a direction substantially parallel to the adjusting scroll with respect to a length of the adjusting scroll. Then the processing module 50 can adjust the desired characteristic of the displayed digital image according to the percentage. An adjusted digital image can be output to and displayed on the touch screen 70.

In another embodiment, the processing module can adjust the desired characteristic of the digital image when the detected slide operation is substantially parallel to the adjusting scroll.

The printing module can print the adjusted digital image. The storage device may record the adjusted distal image when the adjusted digital image is printed.

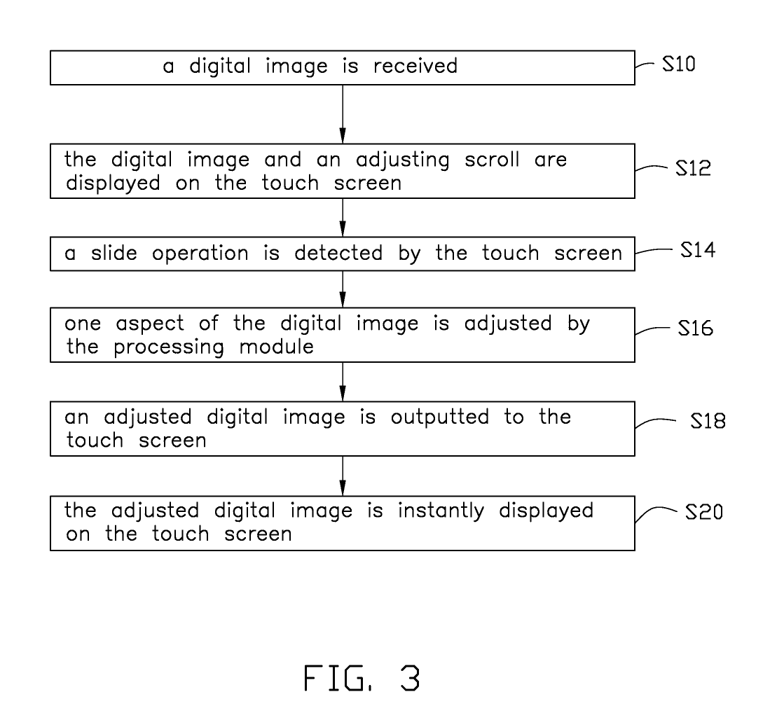

Referring to FIG. 3, steps S10 to S20 indicate a flowchart for processing a digital image in a stand-alone printer in an exemplary embodiment.

In step S10, a digital image is received from the card reader 10 or through the wireless communication module 20. The digital image is then stored in the storage device.

In step S12, the digital image and an adjusting scroll are displayed on the touch screen.

In step S14, a slide operation is detected by the touch screen 70.

In step S16, the digital image is edited by the processing module 50. For example, a desired characteristic, such as brightness, of the digital image is adjusted by the processing module 50 in response to the slide operation on the touch screen 70. In detail, a percentage of a movement distance of the slide operation along a direction substantially parallel to the adjusting scroll with respect to a length of the adjusting scroll is calculated. The processing module 50 adjusts the desired characteristic according to the percentage.

In step S18, an adjusted digital image is output to the touch screen 70.

In step S20, the adjusted digital image is displayed on the touch screen.

The adjusted digital image may be directly printed by the printing module 80. The storage device can further record the adjusted digital image during or after the adjusted digital image is printed.

Depending on the embodiment, certain of the steps of methods described may be removed, others may be added, and the sequence of steps may be altered. It is also to be understood that the description and the claims drawn to a method may include some indication in reference to certain steps. However, the indication used is only to be viewed for identification purposes and not as a suggestion as to an order for the steps.

It is also to be understood, however, that even though numerous characteristics and advantages have been set forth in the foregoing description of preferred embodiments, together with details of the structures and functions of the preferred embodiments, the disclosure is illustrative only, and changes may be made in detail, especially in matters of shape, size, and arrangement of parts within the principles of the disclosure to the full extent indicated by the broad general meaning of the terms in which the appended claims are expressed.

What is claimed is:

1. A stand-alone printer comprising:
a storage module storing a digital image;
a user interface module for creating an adjusting scroll;
a touch screen for detecting a slide operation, and displaying the digital image and the adjusting scroll;
a processing module for adjusting a characteristic of the digital image in response to the slide operation on the touch screen, and the processing module for outputting an adjusted digital image to the touch screen; and
a printing module for printing the adjusted digital image.

2. The stand-alone printer of claim 1, wherein the processing module calculates a percentage of a movement distance of the slide operation along a direction substantially parallel to the adjusting scroll with respect to a length of the adjusting scroll, and the processing module adjusts the characteristic of the image according to the percentage.

3. The stand-alone printer of claim 1, wherein the characteristic comprises brightness of the digital image.

4. The stand-alone printer of claim 1 further comprising a card reader, wherein the card reader is connected to the storage module.

5. The stand-alone printer of claim 1 further comprising a wireless communication module, wherein the wireless communication module is connected to the storage module.

6. The stand-alone printer of claim 1, wherein the storage device stores the adjusted digital image after the adjusted digital image is printed.

7. A method for processing a digital image in a stand-alone printer, the method comprising:
displaying the digital image and an adjusting scroll on a touch screen;
detecting a slide operation on the touch screen;
adjusting a characteristic of the digital image in response to the slide operation on the touch screen;
outputting an adjusted digital image to the touch screen; and
displaying the adjusted digital image on the touch screen.

8. The method of claim 7, wherein the processing module calculates a percentage of a movement distance of the slide operation along a direction substantially parallel to the adjusting scroll with respect to a length of the adjusting scroll, and the processing module is adjusts the characteristic of the image according to the percentage.

9. The method of claim 7, wherein the characteristic of the image comprises brightness of the digital image.

10. The method of claim 7 further comprising reading the digital image from a card reader.

11. The method of claim 7 further comprising receiving the digital image through the wireless communication module.

12. The method of claim 7 further comprising storing the adjusted digital image.
